(19) United States
(12) Patent Application Publication
(10) Pub. No.: US 2024/0268546 A1
(43) Pub. Date: Aug. 15, 2024

(54) BRISTLE DISK

(71) Applicant: Ivoclar Vivadent AG, Schaan (LI)

(72) Inventors: Marvin Kuhn, Feldkirch (AT); Andreas Schülke, Grabs (CH); Hendrik John, Buchs (CH); Urs Lendenmann, Grabs (CH)

(21) Appl. No.: 18/436,310

(22) Filed: Feb. 8, 2024

(30) Foreign Application Priority Data
Feb. 9, 2023 (EP) 23155782.8

(51) Int. Cl. A46B 9/04; A46D 1/00; A46D 3/00

(52) U.S. Cl. CPC A46B 9/045; A46D 1/0284; A46D 3/00; A46B 2200/1066

(57) ABSTRACT

A method of producing a dental arch toothbrush (100), including the steps of detecting (S101) a dental arch shape (101) of a patient; and milling (S102) the dental arch shape (101) out of a disk (103) in which the bristles (105) of the dental arch toothbrush (100) are embedded.

### CROSS-REFERENCE TO RELATED APPLICATIONS

This application claims priority to European Patent Application No. 23155782.8.4 filed on Feb. 9, 2023, the disclosure of which is incorporated herein by reference in its entirety.

### TECHNICAL FIELD

The present invention relates to a method of producing a dental arch toothbrush and a disk for producing a dental arch toothbrush.

### BACKGROUND

Current dental arch toothbrushes use a universal and unadapted mouthpiece for an arrangement of the bristles. The bristles are not customizable in large-scale production, for example, by injection molding.

This results in the problem that with different tooth geometries, sizes or dental arches varying in shape or length, there is no optimum contact between the bristles and the surfaces of the teeth to be cleaned. Also, the interdental spaces cannot be reached optimally.

EP 2 900 171 B1 and corresponding U.S. Pat. No. 9,636,195 B2, which US patent is hereby incorporated by reference in its entirety, relate to an oral hygiene system for cleaning teeth and gingiva. The system has a mouthpiece with a curved channel configured to receive and surround a dental arch with an entire row of maxillary and mandibular teeth with gingiva. However, even this system cannot be optimally adapted to the respective patient-specific dental arch geometries.

### SUMMARY

It is the technical task of the invention to enable the production of an individually adapted dental arch toothbrush.

This technical task is solved by objects according to the independent claims. Technically advantageous embodiments are the subject matter of the dependent claims, the description and the drawings.

According to a first aspect, the technical task is solved by a method of producing a dental arch toothbrush, comprising the steps of detecting a dental arch shape of a patient; and working out or carving out the dental arch shape from a disk in which the bristles of the dental arch toothbrush are embedded. The dental arch shape can also be worked out from the bristles of the dental arch toothbrush which are embedded in a disk.

The disk may be, for example, a plastic disk. The outer portions of the bristles of the dental arch toothbrush may be arranged in a removable support material. The method provides the technical advantage that an individual dental arch toothbrush can be produced in which the tips of the bristles are always in contact with the corresponding place in the patient's mouth. This dental arch toothbrush improves the cleaning of the teeth in the patient's mouth.

In a technically advantageous embodiment of the method, the dental arch shape is detected by means of an intraoral scanner. This provides the technical advantage, for example, that the shape of the dental arch and the individual teeth can be detected easily and quickly.

In another technically advantageous embodiment of the method, the worked-out dental arch shape has smaller dimensions than the detected dental arch shape. It is also possible for only certain sections or areas of the worked-out dental arch shape to have smaller dimensions, such as the interdental spaces. In this case, the bristles have a higher tension in these areas. There may also be a greater distance between the bristles and the dental arch in certain sections or areas. This provides the technical advantage, for example, that the bristles rest against the dental arch with a higher tension.

In another technically advantageous embodiment of the method, the tips of the bristles in the disk are exposed from a support material. This provides the technical advantage, for example, that the dental arch toothbrush can be produced in a simple manner.

In a further technically advantageous embodiment of the method, the tips of the bristles are rounded. This provides the technical advantage, for example, that injuries caused by the bristles can be prevented.

In a further technically advantageous embodiment of the method, the ends of the bristles are exposed from a support material. This provides the technical advantage, for example, that the ends of the bristles can be machined.

In a further technically advantageous embodiment of the method, the exposed ends of the bristles are embedded in a carrier material. This provides the technical advantage, for example, that the ends of the bristles can be fixed in the carrier material.

In another technically advantageous embodiment of the method, the outer shape of the dental arch toothbrush is worked out of the disk, for example by means of a subtractive process. In this process, the length of the dental arch toothbrush can be adjusted, for example depending on whether a wisdom tooth is present or not. The carrier can be shortened, or the individual shape of the carrier can be adjusted. This provides the technical advantage, for example, that the dental arch toothbrush can be produced in a simple manner.

In a further technically advantageous embodiment of the method, the dental arch shape is milled out of the disk and/or the shape of the dental arch toothbrush is milled out of the disk. This provides the technical advantage, for example, that milling enables precise shaping.

According to a second aspect, the technical task is solved by a disk for producing a dental arch toothbrush from a plastic material in which the bristles of the dental arch toothbrush are embedded. The disk forms a blank for the production of the dental arch toothbrush. Thus, the same technical advantages are provided as by the method according to the first aspect.

In a technically advantageous embodiment of the disk, the tips of the bristles are arranged in a dissolvable support material. This also provides the technical advantage, for example, that the dental arch toothbrush can be produced in a simple manner.

In another technically advantageous embodiment of the disk, the dissolvable support material comprises polyethylene glycol, polyvinyl alcohol, or a wax. This can be achieved, for example, by heat so that the support material melts. The support material may also be water soluble. In this case, the support material can be dissolved out by means of water. This provides the technical advantage, for example, of using particularly suitable materials that can be dissolved in a simple manner, for example.

In a further technically advantageous embodiment of the disk, the ends of the bristles are arranged in a carrier material. This provides the technical advantage, for example, that the ends of the bristles can be fixed.

In a further technically advantageous embodiment of the disk, the bristles are arranged directionally or non-directionally, crossed or perpendicular to the tooth surface in the disk. This provides the technical advantage, for example, that the bristles are arranged in a suitable arrangement in the disk.

In another technically advantageous embodiment, disks with different predetermined sizes of the U-shaped bristle arrangement are used in order to be able to reproduce as many dental arch shapes as possible. This provides the technical advantage, for example, that as many tooth sizes and shapes as possible are covered with just a few shapes.

### BRIEF DESCRIPTION OF THE DRAWINGS

Exemplary embodiments of the invention are shown in the drawings and are described in more detail below, in which:

FIG. 1 shows a schematic representation of a disk for producing a dental arch toothbrush;

FIG. 2 shows a schematic representation of a disk for producing a dental arch toothbrush;

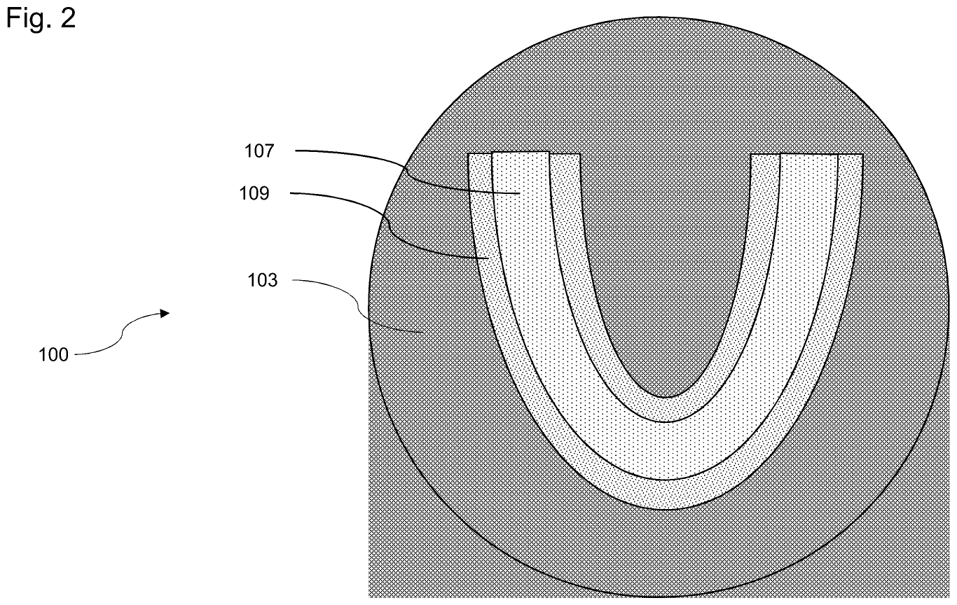

FIG. 3 shows a schematic representation of a disk for producing a dental arch toothbrush with an indication of the embedded bristles;

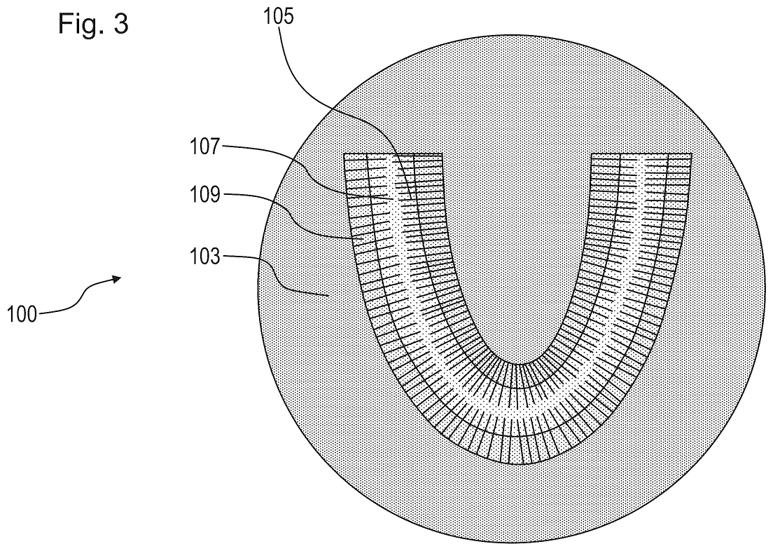

FIG. 4 shows a schematic representation of a disk for producing a dental arch toothbrush with an indication of the embedded bristles and a worked-out dental arch;

FIG. 5 shows a representation of a prototype disk with embedded bristles and worked-out dental arch;

FIG. 6 shows a schematic representation of disks with differently sized arches;

FIG. 7 shows a schematic representation of a dental arch toothbrush; and

FIG. 8 shows a block diagram for producing the dental arch toothbrush.

### DETAILED DESCRIPTION

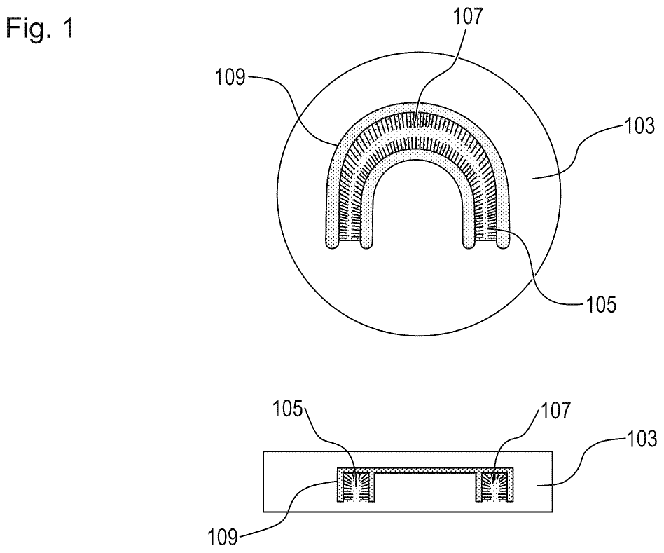

FIG. 1 shows a schematic representation of a round disk 103 for producing a dental arch toothbrush 100 (bristle disk). The disk 103 is formed, for example, as a plastic disk from polyethylene (PE) or polyethylene terephthalate (PET).

Bristles 105 are enclosed within the disk 103 in the course of a dental arch. The bristles 105 are located inside the disk 103. The bristles 105 may be formed of various materials, such as plastic, silicone, or natural fiber.

The bristles 105 may be incorporated in the material in a directional or non-directional manner. The bristles 105 may also be arranged in the material in a crossed or X-shape. The bristles 105 may also be arranged approximately perpendicular to the tooth surface, so as to maximize the cleaning action of the bristles in contact with the tooth surface. In addition, the disk 103 comprises a carrier material 109 in which the ends of the bristles 105 are fixed. The carrier material 109 is formed, for example, from polyethylene (PE), polyethylene terephthalate (PET) or an elastomer, such as silicone.

The other portions of the bristles 105 are surrounded by a support material 107. The bristles 105 are embedded in the support material 107 in an arrangement that allows for customization to the dental arch and shape by separating out the bristles 105. The bristles 105 are thereby embedded within the disk 103 in a support material 107 that is removable or separable around the bristles 105. Removal of the support material 107 around the bristles 105 may be accomplished, for example, by melting the support material 107 or dissolving the support material 107 in a medium, such as water. After removal of the support material 107, the bristles 105 continue to be held in place by the carrier material 109.

The appropriate dental arch size and tooth shape of a patient is first detected via an impression or an intraoral scan. The detected dental arch is then worked out, for example milled, of the material of the disk 103. The most suitable bristle arch can also be selected from a selection of differently sized, U-shaped bristle arches and the length of it can be adjusted. The disk 103 then comprises a recess in the area of the embedded bristles 105 which corresponds to the detected dental arch shape.

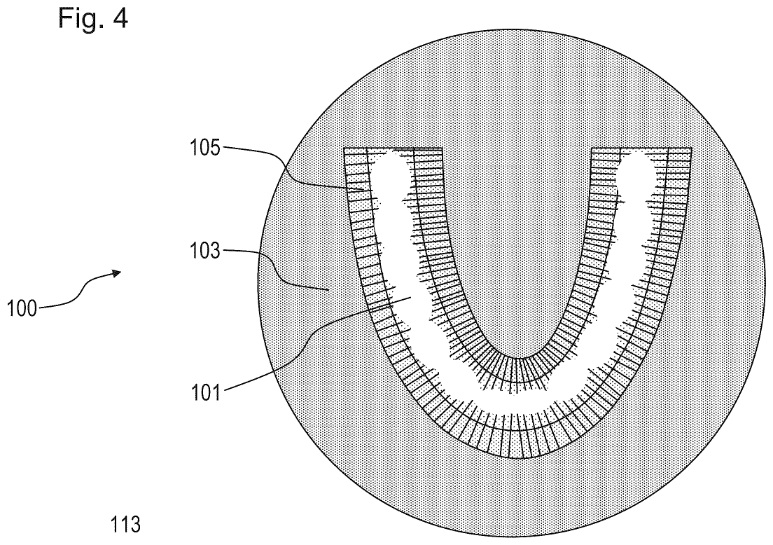

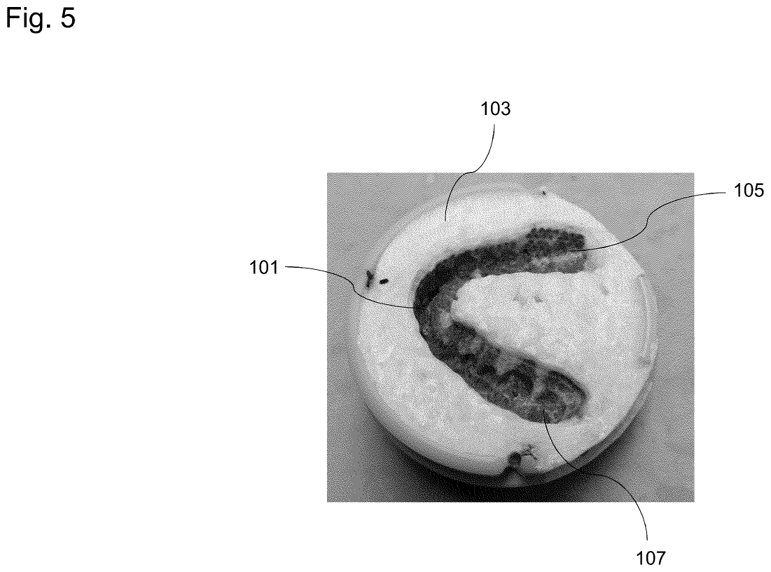

FIGS. 4 and 5 show a representation of the disk 103 with the dental arch shape 101 worked out. In the next step, the tips of the bristles 105 are exposed from the surrounding support material 107. This can be done, for example, by completely or partially dissolving or melting the support material 107.

Removal of the support material 107 may be partial, so that the remaining support material 107 serves as a carrier for the bristles 105. This fixes the ends of the bristles 105. The carrier for the bristles 105 can be created from the remaining support material 107.

If a carrier material 109 for the bristles 105 has already been incorporated into the disk 103, the support material 107 may also be completely removed.

Polyethylene glycol (PEG) can be used as the support material 107 for the bristles 105. Waxes are also suitable as a good support material 107, as these can be liquefied at temperatures above the melting point after milling out the dental arch.

Another possibility is to first partially remove the support material 107 at the ends of the bristles 105 in order to insert a suitable carrier material 109 at these places to fix the bristles 105. The support material 107 is thereby replaced in the transition area to the disk 103 by a suitable carrier material 109.

The remaining support material 107 around the fixed bristles 105 can then be removed. The tips or edges of the bristles 105 can then be rounded. This can be done thermally by melting or chemically by an etching process.

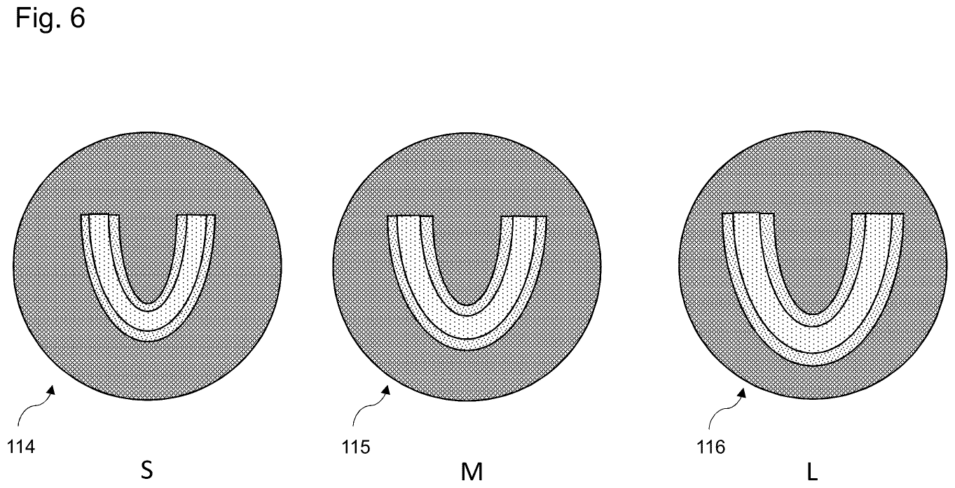

FIG. 6 shows exemplary disks with various predetermined sizes of the U-shaped bristle arrangement 114 to 116 in order to cover as many tooth sizes and shapes as possible with just a few shapes.

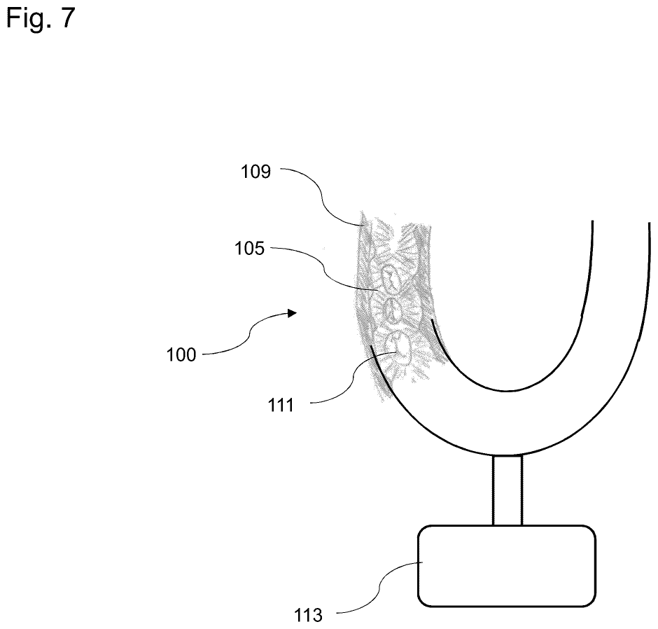

FIG. 7 shows a schematic representation of a dental arch toothbrush 100. Due to the production process, the dental arch toothbrush 100 has bristles 105 that precisely mold the dental arch shape. The bristles 105 are held in place by the carrier material 109.

The dental arch toothbrush 100 can be placed on a patient's dental arch. There, due to the shape, the tips of the bristles 105 are in direct contact with the surface of the dental arch and the teeth 111.

The dental arch toothbrush 100 is coupled to an electro-mechanical vibration generator 113 that causes the bristles 105 to vibrate in a translational or rotational manner. These vibrations clean the teeth 111. An eccentric motor may be used for this purpose, which causes the bristle carrier to move mechanically.

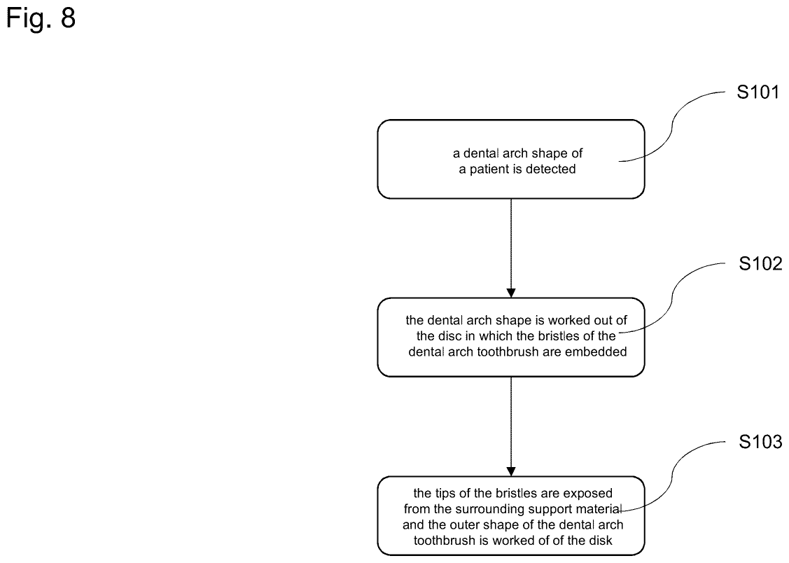

FIG. 8 shows a block diagram for producing the dental arch toothbrush 100. In step S101, a dental arch shape 101 of a patient is detected, such as digitally using an intraoral scanner. In step S102, the dental arch shape 101 is carved or worked out or shaped out of the disk 103 in which the bristles 105 of the dental arch toothbrush 100 are embedded. Then, in step S103, the tips of the bristles 105 are exposed from the surrounding support material 107. Then, the outer shape of the dental arch toothbrush 100 is carved out or worked out of the disk 103. In this way, a U-shaped dental arch toothbrush 100 is obtained in which the bristles 105 are adapted to the individual dental arch shape 101 of the patient.

The method enables individual adaptation of the bristles 105. For this purpose, the bristles 105, which may be made of different materials, are embedded in the support material 107, which may subsequently be completely or partially removed. The method thereby offers the possibility of producing an individually adapted dental arch toothbrush 100 through a digital workflow.

All of the features explained and shown in connection with individual embodiments of the invention may be provided in different combinations in the subject matter of the invention to simultaneously realize its beneficial effects.

All method steps can be implemented by devices which are suitable for executing the respective method step. All functions that are executed by the features of the subject matter can be a method step of a method.

The scope of protection of the present invention is given by the claims and is not limited by the features explained in the description or shown in the figures.

### REFERENCE LIST

100 Dental arch toothbrush
101 Dental arch shape
103 Disk
105 Bristles
107 Dissolvable support material
109 Carrier material
111 Tooth
113 Vibration generator
114 Disk with dental arch size S
115 Disk with dental arch size M
116 Disk with dental arch size L

1. A method of producing a dental arch toothbrush, comprising the steps of:
detecting a dental arch shape of a patient; and
shaping out the dental arch shape from a disk in which the bristles of the dental arch toothbrush are embedded.

2. The method according to claim 1,
wherein the dental arch shape is detected by an intraoral scanner.

3. The method according to claim 1,
wherein the worked-out dental arch shape has smaller dimensions than the detected dental arch shape.

4. The method according to claim 1,
wherein the tips of the bristles in the disk are exposed from a support material.

5. The method according to claim 4,
wherein the tips of the bristles are rounded.

6. The method according to claim 1,
wherein the ends of the bristles are exposed from a support material.

7. The method according to claim 6,
wherein the exposed ends of the bristles are embedded in a carrier material.

8. The method according to claim 1,
wherein the outer shape of the dental arch toothbrush is machined out of the disk.

9. The method according to claim 1,
wherein the dental arch shape is milled out of the disk and/or the shape of the dental arch toothbrush is milled out of the disk.

10. A disk for producing a dental arch toothbrush comprising
a plastic material in which bristles of the dental arch toothbrush are embedded.

11. The disk according to claim 10,
wherein the tips of the bristles are arranged in a dissolvable support material.

12. The disk according to claim 11,
wherein the dissolvable support material comprises polyethylene glycol, polyvinyl alcohol, or a wax.

13. The disk according to claim 10,
wherein the ends of the bristles are arranged in a carrier material.

14. The disk according to claim 11,
wherein the bristles are arranged directionally, non-directionally, crossed or perpendicular to the tooth surface in the disk.
